(19) United States
(12) Patent Application Publication
(10) Pub. No.: US 2019/0100475 A1
(43) Pub. Date: Apr. 4, 2019

(54) Propellant Composition

(71) Applicant: Streamline Automation LLC, Huntsville, AL (US)

(72) Inventors: William M. Chew, Huntsville, AL (US); Geoffrey H. Chew, Huntsville, AL (US)

(21) Appl. No.: 15/724,086

(22) Filed: Oct. 3, 2017

(51) Int. Cl. C06D 5/04; C06B 43/00; F02K 9/42; F02K 9/68

(52) U.S. Cl. CPC C06D 5/04; C06B 43/00; F02K 9/605; F02K 9/68; F02K 9/425

(57) ABSTRACT

Monopropellants comprising nonstoichiometric ratios of 2-hydroxyethylhydrazine cation (HEH+) and nitrate anion and water have improved thermal stability and fluid characteristics compared to nonstoichiometric ratios of HEH+ and nitrate anion without water. These monopropellants are useful for gas generators and rocket motors.

### BACKGROUND OF THE INVENTION

### Field of the Invention

The present invention relates to energetic propellants, monopropellants, and gas generators and rocket motors comprising nitrate salts of 2-hydroxyethylhydrazine.

### Description of Related Art

Hydrazine is commonly used as an energetic monopropellant for orbit and attitude control for satellites and for roll control of launchers. Monomethylhydrazine (MMH) and unsymmetrical dimethylhydrazine (UDMH) are used as energetic fuels in bipropellant systems. These chemicals have desirable performance characteristics but are highly volatile and toxic, and can become unstable during adiabatic compression. For these reasons, much effort has been directed toward the replacement of hydrazine, MMH, and UDMH with less toxic, less volatile, and more stable propellants.

Energetic ionic liquids (ILs) are good candidates for alternatives to hydrazine, MMH, and UDM because they are less volatile and more stable, which makes them easier to handle and store, but also suffer from drawbacks of their own. Hydroxylammonium nitrate (HAN) is an IL that is an unstable crystalline solid at room temperature that is usually formulated in an aqueous solution to reduce the risk of detonation. The aqueous solution, however, is corrosive and toxic, and possibly carcinogenic. HAN can also produce very high temperatures on iridium catalyst beds, which can cause catalyst failure. Adding more water can reduce combustion temperature on the catalyst but more water may also result in relatively poor ignition and response characteristics, which may be overcome by blending HAN with HN (N₂H₄.HNO₃) and triethanol ammonium nitrate TEAN.

U.S. Pat. No. 8,636,860 discloses a gas generator using a monopropellant comprising an energetic ionic liquid monopropellant that reacts with a metal catalyst comprising iridium. The '860 patent discloses that 2-hydroxyethylhydrazinium nitrate (HEHN) salts and other IL propellants do not always react with catalysts in the same way as HAN or hydrazine. Experimentation further revealed that the stoichiometry, i.e. the cation to anion ratio, of these ILs influences both the temperature at which HEHN decomposes on iridium containing catalyst such as S-405® and the intensity with which they decompose. The monopropellants do not contain water.

Current IL monopropellant compositions are safer to handle than their volatile counterparts but still pose a risk of explosion associated with thermal instability, which can make transport expensive. HEHN containing monopropellants can poison Iridium catalysts, preventing pulsing of fuel as well as stopping and restarting gas generators or motors using them. HEHN monopropellants with higher than 1.6:1 ratios of nitrate anion to HEH cation are not liquids at room temperature and must be melted to flow. The present invention improves upon the thermal stability and fluid characteristics of HEHN/HEHN₂, monopropellants and reduces catalyst poisoning by these monopropellants.

### SUMMARY OF THE INVENTION

The present invention provides for monopropellant compositions comprising nitrate salts of 2-hydroxyethylhydrazine (HEH) and water and methods for making them. The monopropellant compositions have improved thermal stability and are safer to transport compared to corresponding anhydrous 2-hydroxyethylhydrazinium nitrate (HEHN) salts. Specific impulse (Isp) values for the corresponding anhydrous HEHN salts are only slightly higher. The monopropellant compositions containing up to 20% water react when contacted with Iridium catalysts at temperatures below 300° C. The invention also provides for a gas generator comprising a fuel tank holding a monopropellant that can be delivered to a reaction chamber where it deflagrates upon contact with a catalyst to produce gas. The invention also provides for a rocket motor comprising a fuel tank holding a monopropellant that can be delivered to a combustion chamber where it ignites upon contact with a catalyst to produce combustion products and thrust.

### DETAILED DESCRIPTION OF THE INVENTION

The term “ionic liquid” (IL) used herein refers to salts (i.e, compositions comprising cations and anions) that are liquid at a temperature at or below about 150° C., that is, at one or more temperature ranges or points at or below about 150° C. Energetic ionic liquids including 2-hydroxyethylhydrazinium (HEH) combined with nitrate resulting in integer or non-integer ratios of HEH cations and nitrate anions.

HEHN, [HO(CH₂)₂NHNH₃]+NO₃—, as the pure compound, has a glass transition temperature of −56.9° C., with an onset to 5% decomposition of 193° C. HEH dinitrate (HEHN₂) [HO(CH₂)2NH₂NH₂]+2NO₂—, is a waxy solid at room temperature with a melting point of 67° C. with an onset to 5% decomposition of 62° C. Non-integer (nonstoichiometric) ratios of HEH cation to Nitrate anion provide certain advantages over HEHN and HEHN₂. For example, the ratio of HEH:Nitrate may be varied to prevent the ignition of the monopropellant in a catalytic gas generator initially operating at a selected catalyst temperature. Anhydrous HEHN/HEHN₂ with HEH:Nitrate ratios of 1:1.2 and 1:1.4 are hypergolic liquids when contacted with an 32% Iridium catalyst at 150° C., while HEH:Nitrate 1:1 is not. Anhydrous compounds having HEH:Nitrate ratios of 1:1.6 and 1:1.8 are waxy solids at room temperature and react spontaneously with 32% Iridium on alumina catalyst at 150° C. Ratios having higher nitrate content are more energetic but less fluid and less thermally stable.

It has now been found the inclusion of water in HEHN/HEHN₂ monopropellant compositions introduces advantages related to thermal stability and fluidity without significantly compromising their performance. For example, the inclusion of water in nonstoichiometric HEHN/HEHN₂ mixtures recused their thermal instability. A solution comprising 16% by weight water and 84% by weight HEHN/HEHN₂ having an HEH ion to Nitrate ion ratio of 1:1.4 can be heated to 75° C. for 48 hours without showing any sign of exothermic decomposition. This type of test result is indicative of a material that is relatively safe for transport compared to the corresponding composition without water. The composition ignites when contacted with a 32% Iridium on alumina catalyst heated to a temperature of 250° C. and deflagrates when contacted with the same catalyst heated to a temperature of 150° C. The theoretical specific impulse (Isp) for this composition is calculated to be 279 seconds, compared to an Isp for the anhydrous HEHN/HEHN₂ 1:1.4 composition of 290 seconds. Both Isp values are higher than that for hydrazine, which has a calculated Isp of 220 seconds.

An aqueous solution comprising 20% by weight water and 80% by weight HEHN/HEHN₂ having an HEH ion to Nitrate ion ratio of 1:1.6 shows no sign of exothermic decomposition when heated to 75° C. for 48 hours, ignites when contacted with Iridium catalyst S405® heated to a temperature of 250° C. and deflagrates when contacted with the catalyst heated to a temperature of 150° C. Generally, the thermal stabilities of HEHN, HEHN₂ and mixtures of the two are improved by the presence of from 5% to 20% of water, resulting in HEHN/HEHN₂ compositions comprising at least 80% HEHN+HEHN₂ by weight.

The presence of water in an amount of 10% by weight in a composition having an HEH:Nitrate ratio of from 1:1.6 to 1:1.8 provides a liquid solution that ignites upon contact with 32% Iridium on alumina catalyst at 250° C. to produce only a slightly lower theoretical Isp than the anhydrous compounds. The liquid solution deflagrates on contact with 32% Iridium on alumina catalyst at 150° C.

Compositions according to the invention may comprise combinations of HEHN and HEHN₂ in non-stoichiometric ratios of HEH cation to Nitrate anion of 1:1.2, 1:1.3, 1:1.4, 1:1.5, 1:1.6, 1:1.7, 1:1.8, and 1:1.9. In preferred embodiments, the ratio of HEH cation to Nitrate anion is between 1:1.4 and 1:1.6. These compositions can be made by dropwise adding concentrated nitric acid in the desired stoichiometric ratio to HEH at 0° C. Water may then be removed by rotoevaporation and/or molecular sieve until the desired water content is obtained. HEHN and HEHN₂ can also be synthesized as disclosed in U.S. Pat. No. 8,636,860 and mixed together in a desired ratio. Aqueous solutions or mixtures of HEHN, HEHN₂ and combinations thereof may be made by adding water to pure HEHN/HEHN₂ and may comprise from 80% to 99% HEHN+HEHN₂, preferably 80% to 90% HEHN+HEHN₂ by weight.

Generally, solutions comprising up to 20% water and HEHN/HEHN₂ having HEHN:Nitrate ratios of 1:1.4 to 1:1.8 have calculated Isp values only marginally lower than their anhydrous counterparts. Aqueous solutions of HEHN/HEHN₂ with HEHN:Nitrate ratios of 1:1.5 to 1:1.8 and 5%-20% by weight water do not poison 32% Iridium on alumina catalyst.

The monopropellants of the invention may be used in a gas generator and/or in a method for generating a gas. In a gas generator, gas is produced by contacting the monopropellant with an iridium catalyst that may be heated to a temperature sufficient for the monopropellant to deflagrate upon contact with the catalyst.

The monopropellants of the invention may be used in a rocket motor and/or in a method for generating thrust. In a rocket motor, thrust may be produced by contacting the monopropellant with an iridium catalyst in a combustion chamber. The catalyst may be heated to a temperature sufficient for the monopropellant to ignite upon contact with the catalyst.

1. A gas generator comprising a storage tank containing a liquid propellant and a reaction chamber comprising an iridium catalyst wherein:
said reaction chamber comprises an inlet configured to receive said liquid propellant from the storage tank such that said liquid propellant reacts upon contact with said catalyst and thereby decomposes said liquid propellant to produce a gas,
said reaction chamber comprises an outlet configured to release a gas from the reaction chamber,
said liquid propellant comprises water and an ionic liquid comprising 2-hydroxyethylhydrazinium cations (HEH+) and nitrate ions, said HEH+ cations and said nitrate ions being present in a ratio of from 1:1.1 to 1:1.9, and
said water is present in an amount of from 5% to 20% by weight and said ionic liquid is present in an amount of from 80% to 95% by weight.

2. The gas generator of claim 1, wherein the iridium catalyst comprises 31% to 35% iridium metal on alumina.

3. The gas generator of claim 1, wherein the ratio of HEH+ cations to nitrate ions ranges from 1:1.4 to 1:1.6.

4. The gas generator of claim 1, wherein the reaction chamber further comprises a heater configured to heat the catalyst and/or the reaction chamber.

5. The gas generator of claim 4, wherein the heater is configured to heat the catalyst to a temperature of between 125° C. and 175° C.

6. The gas generator of claim 1, wherein said energetic ionic liquid, said catalyst, and a catalyst temperature are selected such that gas is produced without ignition of said energetic ionic liquid.

7. A rocket motor comprising a storage tank containing a liquid propellant and a combustion chamber comprising an iridium catalyst,
wherein:
said combustion chamber comprises an inlet configured to receive said liquid propellant from the storage tank such that said liquid propellant contacts and reacts upon contacting said catalyst and thereby decomposes said liquid propellant to produce a gas,
said combustion chamber comprises an outlet configured to release said gas from the combustion chamber,
said liquid propellant comprises water and an ionic liquid comprising 2-hydroxyethylhydrazinium cations (HEH+) and nitrate ions, said HEH+ cations and said nitrate ions being present in a ratio of from 1:1.1 to 1:1,9, and
said water is present in an amount of from 5% to 20% by weight and said ionic liquid is present in an amount of from 80% to 95% by weight.

8. The rocket motor of claim 7, wherein the ratio of HEH+ cations to nitrate ions ranges from 1:1.4 to 1:1.6.

9. The rocket motor of claim 7, wherein the reaction chamber further comprises a heater configured to heat the catalyst and/or the reaction chamber.

10. The rocket motor of claim 9, wherein the heater is configured to heat the catalyst to a temperature of less than 300° C.

11. The rocket motor of claim 9, wherein the heater is configured to heat the catalyst to a temperature of between 200° C. and 300° C.

12. A method for preparing a nonstoichiometric 2-hydroxyethylhydrazinium nitrate propellant, said method comprising:
mixing liquid 2-hydroxyethylhydrazine with concentrated nitric acid in a mixing vessel while maintaining a temperature of less than 25° C. inside the mixing vessel to form a reaction product comprising 2-hydroxyethylhydrazinium cations and nitrate anions in an aqueous solution and
removing water from the reaction product until the weight percent of water is between 5% and 20%
wherein the molar ratio of concentrated nitric acid to 2-hydroxyethylhydrazin is between 1.1:1 and 1.9:1.

13. The method of claim 12, wherein the molar ratio of concentrated nitric acid to 2-hydroxyethylhydrazin is between 1.1:4 and 1:1.6.

14. The method of claim 12, wherein water is removed from the reaction product until the weight percent of water is between 5% and 20%.
